(19) United States
(12) Patent Application Publication
(10) Pub. No.: US 2007/0113500 A1
(43) Pub. Date: May 24, 2007

(54) Method to Regulate temperature and Reduce Heat Island Effect

(76) Inventor: Joe Ru He Zhao, Vancouver (CA)

Correspondence Address: JOE RU HE ZHAO, 3167 PARKER STREET, VANCOUVER, BC, V5K 2V4, CA

(21) Appl. No.: 11/668,467

(22) Filed: Jan. 30, 2007

(30) Foreign Application Priority Data
Aug. 30, 2005 (CA) 2,515,822

(51) Int. Cl. B32B 3/26; E04C 1/42; F24H 7/00; F24J 2/34

(52) U.S. Cl. 52/306; 126/618; 126/400; 126/617; 428/305.5

(57) ABSTRACT

The present invention relates to a method of regulating and controlling surface temperature of concrete or asphalt structure (the structure) and the like, as well as atmospheric or air temperature around the structure by encapsulating and containing temperature (thermal) control materials (TCMs) or/and water in the structure which constructs or constitutes pavements, roofs, parking lots, walls and the like. Volume ratio of water and one or more TCMs encapsulated and contained in the structure are from 0.01% to 99.99%. Based on simulation analysis, on one hand, the present invention, in summertime, can reduce the highest temperature on surface of the structure by up to 56.5% (reduced by about 46° C.), and reduce the highest temperature of air around the structure by up to 54.4% (reduced by about 48° C.), therefore “heat island” effect in urban areas in summer can significantly be reduced, thus saving cooling energy and benefiting human health. On the other hand, in wintertime, by the invention the surface temperature of the structure can be raised by up to 5.6° C., and the temperature of air around the structure can be raised by up to 5° C., accordingly heating energy demand is reduced.

### FIELD OF THE INVENTION

This invention relates to a method by encapsulating and containing temperature (thermal) control materials (TCMs) or/and water in pavements, roofs, parking lots and walls which are concrete or asphalt structure and the like, to regulate surface and atmospheric or air temperature around the structure to eliminate “heat island” effect in urban areas in summertime or hotter periods, accordingly saving cooling energy and benefiting human health, also saving heating energy in wintertime or colder periods.

### BACKGROUND OF THE INVENTION

The development of cities replaces natural lands, forests and open grassy fields with pavements, buildings and other infrastructures, the relationship between incoming sun radiation and outgoing terrestrial radiation within watershed areas has been changed. The conversion of pervious surfaces to impervious surfaces alters local energy balances through changes in (1) the albedos of surfaces; (2) the heat capacities and thermal conductivities of surfaces; (3) the ratio of sensible heat to latent heat flowing from the surface into the atmosphere. Moreover, displacing trees and vegetation minimizes the natural cooling effects of shading and evaporation of water from soil and leaves (evapotranspiration); and tall buildings and narrow streets can heat air trapped between them and reduce air flow. In addition, waste heat from vehicles, factories, and air conditioners may add warmth to their surroundings. These changes in urban areas lead to urban air and surface temperatures are higher than nearby rural areas. This is referred to as “heat island” effect. Many U.S. cities and suburbs in summertime have air temperatures up to 5.6° C. (10° F.) warmer than the surrounding natural land cover. In some cities in the world the air temperatures in summer have up to 10° C. (18° F.) higher than the rural areas.

Heat islands are of growing concerns. Elevated temperatures in summertime can impact communities by increasing energy demand, air conditioning costs, air pollution levels, and heat-related illness and mortality. Summertime heat islands may also contribute to global warming by increasing demand for air conditioning, which results in additional power plant emissions of heat-trapping greenhouse gases. In U.S. cities with populations over 100,000, peak utility loads increase 2.5˜3.5% for every 1° C. (1.8° F.) increase in summertime temperature. Higher temperatures in urban heat islands bring with them increased energy use, mostly due to a greater demand for air conditioning. Steadily increasing downtown temperatures over the last several decades mean that 3˜8% of community-wide demand for electricity is used to compensate for the heat island effect. On warm afternoons in Los Angeles, for example, the demand for electric power rises nearly 2% for every 0.56° C. (1° F.) of the daily maximum temperature rises. In total, it is estimated that about 1˜1.5 gigawatts of power are used to compensate for the impact of the heat island. This increased power costs the Los Angeles ratepayers about $100,000 USD per hour, about $100 million USD per year.

The heat island effect is one factor among several that can raise summertime temperatures to levels that pose a threat to human health. Extremely hot weather can result in illness including physiological disruptions and organ damage and even death. Excessive heat events or abrupt and dramatic temperature increases are particularly dangerous and can result in above average rates of mortality. Under certain conditions, excessive heat also can increase the rate of ground-level ozone formation, or smog, presenting an additional threat to health and ecosystems within and downwind of cities. It is estimated that probability of smog increases by 3% for every 0.56° C. (1° F.) rise in daily maximum temperature above 21° C. (70° F.). Ozone can be formed when precursor compounds react in the presence of sunlight and high temperatures. Exposure to ambient ozone, even at low levels, may trigger a variety of health problems, especially in vulnerable populations such as children, the elderly, and those with pre-existing respiratory disease. Because wind can carry ozone and its precursors hundreds of miles, even residents far away from urban centers and sources of pollution can be at risk. The specific health effects associated with ozone exposure include irritating lung airways and causing inflammation, possible permanent lung damage by repeated exposure to ozone pollution for several months, as well as resulting in aggravated asthma, reduced lung capacity, and increased susceptibility to respiratory illnesses by even low-level exposure, etc. In addition, ozone pollution can damage vegetation and ecosystems within and downwind of cities. For instance, ground-level ozone interferes with the ability of plants to grow and store food. Ozone also damages the foliage of trees and other vegetation, reducing crop and forest yields, and tarnishing the visual appeal of ornamental species and urban green spaces.

There are a number of ways to lessen the impacts of heat islands. These include: (1) Planting trees and vegetation; (2) installing cool or vegetated green roofs (cool roofs); (3) switching to cool paving materials (cool pavements).

Increasing the cover of trees and vegetation in a city is a simple and effective way to reduce the urban heat island effect. Trees have been used to cool homes for hundreds of years. Trees and vegetation have great potential to cool cities by shading and by “evapotranspiration”. Evapotranspiration occurs when plants transpire water through pores in their leaves, the water draws heat as it evaporates, thus cooling the air in the process. Trees also provide a wide range of other benefits such as reducing storm water runoff. Shade trees also can make homes and buildings significantly more energy efficient. It is estimated that strategically planting trees and vegetation reduces cooling energy consumption by up to 25%.

“Cool roofs” is used to describe roofing materials that have high sun reflectances or albedos. These materials reflect a large portion of sun radiation. Cool roofs also may have a high thermal emittance, thus release a large percentage of absorbed heat. This keeps the material cooler and helps to reduce the heat island effect. There are two types of cool roofs: those used on low-slope or flat buildings and those used on steep-sloped buildings. Most cool roof applications for low-slope buildings have a smooth, bright white surface to reflect sun radiation, reduce heat transfer to the interior, and reduce summertime air conditioning demand. Most cool roof applications for steep-slope buildings come in various colors and can use special pigments to reflect the sun radiation. On a hot, sunny, summer day, traditional roofing materials may reach summertime peak temperatures of up to 88° C. (190° F.). By comparison, cool roofs may only reach peak temperatures of 49° C. (120° F.). Another alternative to traditional roofing materials is rooftop gardens or “green roofs.” Installed widely in a city, green roofs contribute to heat island reduction by replacing heat-absorbing surfaces with plants, shrubs, and small trees that cool the air through evapotranspiration. Planted rooftops remain significantly cooler than a rooftop constructed from traditional materials. Moreover, green roofs reduce summertime air conditioning demand by lowering heat gain to the buildings.

The method of “cool pavements” is using cool paving materials to minimize the absorption of sun radiation and the subsequent transfer of this heat to the surroundings. There are two types of cool paving materials: lighter-colored materials and porous materials. Lighter-colored materials have higher sun reflectance, so they absorb less of the sun radiation and stay cooler. Lighter-colored materials come in shades of white, beige, light gray and terra cotta. Porous or permeable pavements allow water to filter into the ground, keeping the pavements cool when moist. Permeable pavements can be constructed from a number of materials including concrete, asphalt and plastic lattice structures filled with soil, gravel and grass.

Planting trees and vegetation is doubtlessly an effective way to lower temperature and reduce the heat island effect. Water contained in plants has a high heat capacity to store more heat and evapotranspiration lowers surface temperature. The way of “green roofs” has the similar effect to that of trees and vegetation. “Cool roofs” and lighter-colored pavements with higher albedos can reflect more sun radiation to space so that the surface temperature is lowered. Pervious pavements of “tool pavements” can lower temperature by a way of evaporation of water contained in pores. All of these ways or a combination of them can, to some extent, reduce the heat island effect. Unfortunately, these methods pose some disadvantages. Firstly, urban areas are impossible and impractical to be all covered by trees and vegetation. Secondly, very high albedo surface can not be used in driveways or some areas where higher albedos may affect human activities. In addition, higher albedo surface can lower surface temperature in wintertime, which suffers from an increase in heating energy demand. Lastly, pervious pavements can only be applied in areas where the strength of the surface is not importantly required. Furthermore, the dust and soils filled in the pores will significantly reduce their permeability and efficiency in a shorter period. High-performance permeable concrete described in U.S. Pat. No. 6,875,265 B1 may partially overcome this problem.

Additional improved methods to combine with the methods addressed above are required to overcome the disadvantages to reduce the heat island effect.

The following Patents and References are cited:

Canadian Patents:

2,286,011 Bryant et al

U.S. Patents:

U.S. Pat. No. 6,875,265 B1 Kang

U.S. Pat. No. 6,487,830 B2 Robertson

U.S. Pat. No. 6,500,555 B1 Khaldi

U.S. Pat. No. 6,627,106 B1 Lotz et al

U.S. Pat. No. 4,556,501 Saita et al

U.S. Pat. No. 6,482,332 B1 Malach

### REFERENCES

http://www.epa.gov/heatisland/
http://eetd.lbl.gov/Heatlsland/
http://www.eere.energy.gov/
Ahrens, C. Donald, Meteorology Today: An Introduction to Weather, Climate, and the Environment, Brooks/Cole (2002).
Hamdan, M. and Elwerr, F., Thermal Energy Storage Using a Phase Change Material, Solar Energy, (56:2) pp. 183-189 (1996).
Hawes, D., Feldman, D. and Banu, D., Latent Heat Storage in Building Materials, Energy and Buildings, (20:1) pp. 77-86 (1993).

### SUMMARY OF THE INVENTION

The object of the present invention is to provide a method to resolve the problems described above, by encapsulating and/or incorporating temperature (thermal) control materials (TCMs) or/and water in pavements, roofs, parking lots and/or walls which are concrete or asphalt structure and the like (the structure). In the invention the capacity of heat storage of the structure has been increased to store more heat energy, consequently lowering surface and air temperature, thus reducing heat island effect. Water or/and one or more TCMs are encapsulated, incorporated and/or contained in forms of microspheres, microcapsules, capsules, small hollow balls, closed-end tubes or pipes and containers and the like or dispersed and distributed in the structure. The shell materials for microspheres, microcapsules, capsules, small hollow balls, closed-end tubes or pipes, hollow containers can be metals, alloys, natural or synthetic materials, and the volumetric ratio of water or TCMs, or a combination of water and one or more TCMs in the structure is from 0.01% to 99.99%. The water used may be natural water, or water from various water sources that may contain impurity, without or with additives, natural or synthetic, which may be used for the purpose of regulating the freezing point and boiling point of water. TCMs may be phase change materials (PCMs), or/and materials or matters used to control or regulate temperature by chemical bonds or chemical reactions and have capacities to store thermal energy. The method in this invention can reduce the highest temperature on surface of the structure by up to 56.5% (for example, from 82.3° C. (180.1° F.) to 35.8° C. (96.4° F.)), and reduce the highest temperature of air around the structures by up to 54.4% (for example, from 88.9° C. (192° F.) to 40.5° C. (104.9° F.)). Moreover, by the present invention, the daily average temperature in summer on surface of the structures can be reduced by up to 50.7% (for example, from 56.6° C. (133.9° F.) to 27.9° C. (82.2° F.)), and the daily average temperature in air around the structures can be reduced by up to 45% (for example, from 65.6° C. (150.1° F.) to 35.9° C. (96.6° F.)). Lastly, in wintertime, by the present invention, the surface temperature of the structures can be raised by up to 5.6° C., and the temperature of air around the structures can be raised by up to 5° C. The present invention, on one hand, can significantly reduce surface and air temperature in summertime or hotter periods to eliminate the heat island effect and save cooling energy as well as benefiting human health. On the other hand, the present invention can raise the temperature in wintertime or colder periods to decrease heating energy demand.

### BRIEF DESCRIPTION OF THE DRAWINGS

FIG. 1 is a cross-section view of concrete or asphalt structure and the like (the structure) with distributed microspheres, microcapsules, capsules, small hollow balls or particles, and the like which encapsulate and contain water or/and TCMs.

FIG. 2 is a cross-sectional view of the microspheres, microcapsules, capsules, small balls and the like, which encapsulate and contain water or/and TCMs shown in FIG. 1.

FIG. 3 is a cross-section view of concrete or asphalt structure and the like (the structure) with distributed hollow balls, tubes, pipes and the like which contain water or/and TCMs.

FIG. 4 shows a closed-end tube or pipe containing water or TCMs used in FIG. 3.

FIG. 5 is another shape of container that may be used to contain water or TCMs in FIG. 3.

FIG. 6 shows typical surface temperature curve on concrete or asphalt structure and air temperature curve over the structure in a hot summer day.

FIG. 7A shows the effect of water volume ratio contained in concrete or asphalt structure on surface temperature in a hot summer day (sun radiation after deducted reflectance is simulated to be stable and continuous for 5 hours at 1 kw/m², and then 0 for another 5 hours).

FIG. 7B shows the effect of water volume ratio contained in concrete or asphalt structure on air temperature over the structure in a hot summer day (sun radiation after deducted reflectance is simulated to be stable and continuous for 5 hours at 1 kw/m², and then 0 for another 5 hours).

FIG. 8A shows the effect of water volume ratio contained in concrete or asphalt structure on surface temperature in a summer day (sun radiation after deducted reflectance is simulated to be stable and continuous for 5 hours at 0.5 kw/m², and then 0 for another 5 hours).

FIG. 8B shows the effect of water volume ratio contained in concrete or asphalt structure on air temperature over the structure in a summer day (sun radiation after deducted reflectance is simulated to be stable and continuous for 5 hours at 0.5 kw/m², and then 0 for another 5 hours).

FIG. 9A shows the effect of water volume ratio contained in concrete or asphalt structure on surface temperature in a winter day (sun radiation after deducted reflectance is simulated to be stable and continuous for 5 hours at 0.2 kw/m², and then 0 for another 5 hours).

FIG. 9B shows the effect of water volume ratio contained in concrete or asphalt structure on air temperature over the structure in a winter day (sun radiation after deducted reflectance is simulated to be stable and continuous for 5 hours at 0.2 kw/m², and then 0 for another 5 hours).

FIG. 10A gives the simulated results of effect of water in concrete (or asphalt) structure on the highest surface temperature in a day.

FIG. 10B gives the simulated results of effect of water in concrete (or asphalt) structure on the highest air temperature over the structure in a day.

FIG. 11A gives the simulated results of changes of daily average surface temperature due to water contained in concrete (or asphalt) structure compared to no-water in the structure in a day.

FIG. 11B gives the simulated results of changes of daily average air temperature due to water contained in concrete (or asphalt) structure compared to no-water in the structure in a day.

FIG. 12A shows the effect of a TCM contained in concrete or asphalt structure on surface temperature in a hot summer day (sun radiation after deducted reflectance is simulated to be stable and continuous for 5 hours at 1 kw/m², and then 0 for another 5 hours).

FIG. 12B shows the effect of a TCM contained in concrete or asphalt structure on air temperature over the structure in a hot summer day (sun radiation after deducted reflectance is simulated to be stable and continuous for 5 hours at 1 kw/m², and then 0 for another 5 hours).

FIG. 13A shows the effect of a TCM contained in concrete or asphalt structure on surface temperature in a summer day (sun radiation after deducted reflectance is simulated to be stable and continuous for 5 hours at 0.5 kw/m², and then 0 for another 5 hours).

FIG. 13B shows the effect of a TCM contained in concrete or asphalt structure on air temperature over the structure in a summer day (sun radiation after deducted reflectance is simulated to be stable and continuous for 5 hours at 0.5 kw/m², and then 0 for another 5 hours).

FIG. 14A shows the effect of a TCM contained in concrete or asphalt structure on surface temperature in a wither day (sun radiation after deducted reflectance is simulated to be stable and continuous for 5 hours at 0.2 kw/m², and then 0 for another 5 hours).

FIG. 14B shows the effect of a TCM contained in concrete or asphalt structure on air temperature over the structure in a winter day (sun radiation after deducted reflectance is simulated to be stable and continuous for 5 hours at 0.2 kw/m², and then 0 for another 5 hours).

FIG. 15A gives the simulated results of effect of a TCM in concrete (or asphalt) structure on the highest surface temperature in a day.

FIG. 15B gives the simulated results of effect of a TCM in concrete (or asphalt) structure on the highest air temperature over the structure in a day.

FIG. 16A gives the simulated results of changes of daily average surface temperature due to TCM in concrete (or asphalt) structure compared to no-TCM in the structure in a day.

FIG. 16B gives the simulated results of changes of daily average air temperature due to TCM in concrete (or asphalt) structure compared to no-TCM in the structure in a day.

### DETAILED DESCRIPTION OF THE INVENTION

Surface materials respond differently when exposed to the same amounts of sun radiation. Some heat rapidly whereas others heat slowly. This property is called specific heat or heat capacity of the materials. Water has the highest heat capacity among almost all the materials and matters we know. For example, heat capacity of water at 20° C. is 1.16 kwh/(m³K), concrete at 20° C. has a heat capacity of 0.54 kwh/(m³K). And, asphalt used for pavements or roofs has nearly the same figure of heat capacity as concrete. A lower heat capacity leads to lower heat storage. Under the same sun radiation, the temperature on surface with a lower heat capacity will increase more than the surface with a higher capacity. It is understandable that high capacity of heat storage can lower surface temperature. It is expected that the surface materials encapsulating and containing water will have lower temperature than the structure of concrete or asphalt only.

The materials used to control or regulate temperature by heat storage capacity can be defined as temperature (thermal) control materials (TCMs). Phase change materials (PCMs) can be included as one group of TCMs. PCMs use chemical bonds to store and release heat and they are latent heat storage materials. Most PCMs in practical application now are solid-liquid materials and used for solar thermal storage in space heating systems. The thermal energy transfer occurs when a solid-liquid PCM changes from a solid to a liquid, or from a liquid to a solid. This is called a change in state, or “phase change”. Initially, PCMs perform like conventional materials; their temperature rises as they absorb heat. Unlike conventional materials, when PCMs reach the temperature at which they change phase they absorb large amounts of heat without increasing temperature. When temperature around the PCMs drops, the PCMs change phase again, releasing the stored latent heat. PCMs absorb and release heat while maintaining a nearly constant temperature. Solid-solid PCMs absorb and release heat in the same manner as solid-liquid PCMs. These materials do not change into a liquid state under normal conditions. They merely soften or harden. Liquid-gas PCMs have a high heat of transformation, but the increase in volume during the phase change from liquid to gas makes their use difficult. Insulated chambers in packaging systems described in U.S. Pat. No. 6,482,332 B1 is an example of using PCMs to control temperature.

The TCMs used in the present invention can be water, and PCMs or their mixtures including salt hydrates, salt hydrides, paraffin waxes, linear crystalline alkyl hydrocarbons, fatty acids and esters, polyethylene glycols, long alkyl side chain polymers, the solid state series of pentaerythritol, pentaglycerine, neopentyl glycols, low melting metals and alloys, quaternary ammonium clathrates and semi-clathrates, etc. For example, 1-dodecanol, having melting point of 24° C. and latent heat of about 50 kwh/m³, is used in the simulation of temperature control in the present invention.

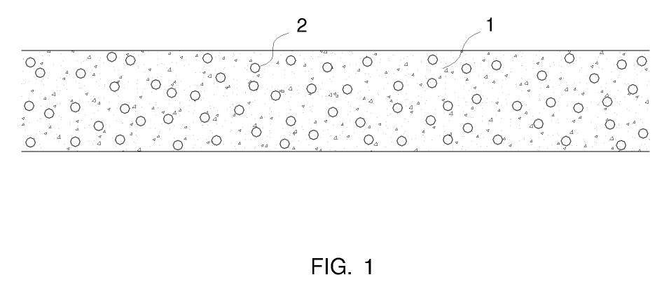

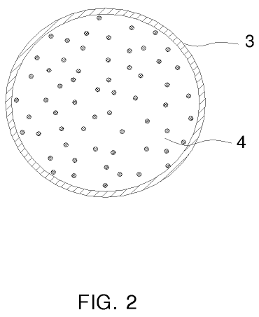

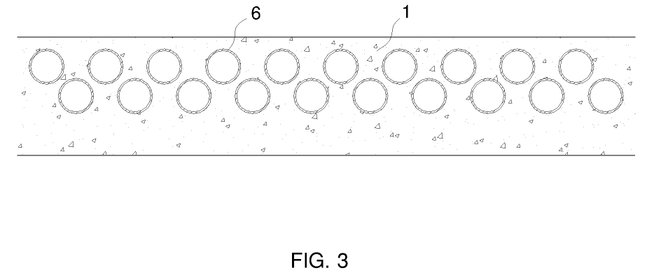

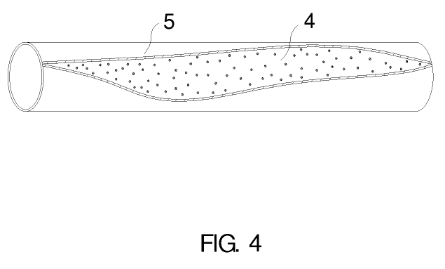

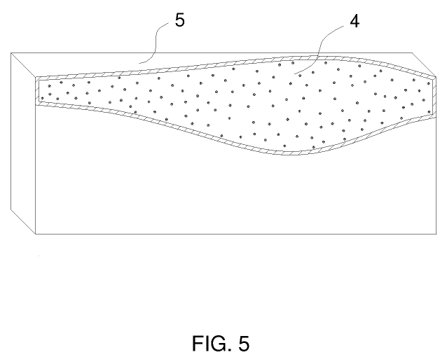

One embodiment of the method of the present invention is shown in FIG. 1 and FIG. 3. The small hollow balls 2 in FIG. 1 that contain water or temperature (thermal) control materials (TCMs) or TCM particles 4 in FIG. 2, FIG. 4 and FIG. 5, are dispersed or distributed in concrete or asphalt structure 1, and the like. The small hollow balls or particles 2 can be microspheres, microcapsules, capsules or TCM particles as shown in FIG. 2. The closed-end tubes or pipes, closed hollow containers 6 and the like containing water or TCMs distributed in the concrete or asphalt structure is shown in FIG. 3. The materials of shell 3 of the small balls in FIGS. 2 and 5 in FIG. 4 and FIG. 5 can be metals, alloys, natural or synthetic materials. Furthermore, the volumetric ratio of water or TCMs, or a combination of water and one or more TCMs in the structure are from 0.01% to 99.99% that is a maximum limit reached by very thin shell material and very large structure with no concrete or asphalt and the like. The water used may be natural water, or water from any water sources that may contain impurity, with or without additives, natural or synthetic, which may be used for the purpose of regulating the freezing point and boiling point of water. TCMs may be phase change materials (PCMs), or/and materials or matters used to control or regulate temperature by latent heat or chemical bonds or chemical reactions and have capacities to store thermal energy. The microspheres, microcapsules, capsules or particles can be formed according to conventional methods well known to those skilled in the prior art. The particles 2 in FIG. 1 can also be expanded perlite particles or exfoliated or expanded vermiculite particles and the like that have high capacities of absorbing water or TCMs and after absorption the particles are coated or the pores of the articles are sealed with one or more polymers or binders such as epoxy resin, rubber or others before mixed with concrete or asphalt in the structure.

To demonstrate the effectiveness of the present invention, some analysis and simulation are described below.

The sun radiation at the surface of concrete or asphalt structure can be expressed as
dQₛᵤₙ=W·A·dt (1)

Where dQₛᵤₙ is thermal energy from sun radiation arriving at the surface of concrete or asphalt structure, in kwh. W is intensity of sun radiation, in kw/m². A is area of surface receiving sun radiation, in m². dt is time interval, in hours.

When the sun radiation arrives at the surface, a portion of heat energy is absorbed by the surface, and another portion is reflected to space by
dQ_{ref}=β·W·A·dt (2)

Where dQ_{ref} is the portion of sun radiation reflected to the space. β is reflectance or albedo of the surface. Therefore, the heat energy from sun radiation absorbed by the surface is
dQ_{ab}=(1-β)·W·A·dt (3)

The total amount of emission from a surface (long-wave radiation, or infrared radiation) is given by the Stefan-Boltzmann law:
E=σ·T⁴ (4)

Where E is intensity of emission, in w/m². σ is Stefan-Boltzmann constant, 5.67×10⁻¹¹ kw/(m²K⁴). T is absolute temperature of the surface, in K.

The heat energy emitted from the surface is then given by
dQₑ=δ·σ·T⁴·A·dt (5)

Where δ is emittance of the surface.

The heat exchange between the surface and the air over the surface is also conducted by conduction and convection expressed as
dQ_{c}=Kₑ·(T−Tₐ)·A·dt (6)

Where K_{c} is a coefficient of combined conduction and convection around the surface, in kw/(m²K). Tₐ is absolute temperature of the air over the surface, in K.

If a thickness b of the structure is considered and assuming that heat loss from the opposite side that has no sun radiation is neglected, the net heat energy that the structure retained in time interval dt is
dQ_{CT}=dQ_{ab}−(dQₑ+dQ_{c}) (7)

It is the heat energy dQ_{CT} that heats the surface and raises the temperature. If the structure is concrete or asphalt, the relation between temperature and dQ_{CT} may be given by

$${Q}_{CT} = {\int }_{0}^{t} ⅆ {Q}_{CT} = b \cdot A \cdot {C}_{PC} \cdot ( {T}_{C} - {T}_{C 0} ) \qquad ( 8 )$$

Where b is thickness of concrete or asphalt structure in question, in m. C_{PC} is average heat capacity of the structure, in kwh/(m³K). T_{C} and T_{C0} are average temperatures of the structure at time t and time 0 respectively, in K.

The air temperature over the structure can be expressed as
hₐ·A·C_{Pa}·(Tₐ−Tₐ₀)=λ·Qₑ+Q_{c} (9)

Where hₐ is thickness or height of air over the structure in question, in m. C_{Pa} is average heat capacity of the air, in kwh/(m³K). Tₐ and Tₐ₀ are average air temperatures over the structure at time t and time 0 respectively, in K. λ is coefficient of air absorbing heat energy emitting from the surface of the structure.

In addition, if a linear temperature distribution along the direction of thickness b of the structure is considered, the surface temperature and average temperature of the structure may be given by
T=2·T_{C}−T_{b} (10)

Where T_{b} is temperature at the opposite side of the structure that has no sun radiation, in K.

In the present invention, water or TCMs are encapsulated or contained in the structure. If water is contained in the structure, Equation (8) may be extended to a form of
Q_{CT}=b·A·(T_{C}−T_{C0})·[C_{PC}+η·(C_{PW}−C_{PC})] (11)

Where η is volume ratio of water contained in the structure. C_{PW} is average heat capacity of water, in kwh/(m³K).

Comparing Equation (11) to Equation (8), using Equation (10) and assuming T_{b} is constant, it can be obtained that:

$$\frac{{T}_{η = η} - {T}_{0 , η = η}}{{T}_{η = 0} - {T}_{0 , η = 0}} = \frac{{C}_{PC}}{{C}_{PC} + η \cdot ( {C}_{PW} - {C}_{PC} )} \qquad ( 12 )$$

Where T₀ is surface temperature of the structure at time 0. T_{η=η} and T_{η=0} are surface temperature of the structure with water volume ratio of η and 0 at time t respectively. As an approximation, if assuming C_{PW}=1.16 kwh/(m³K) and C_{PC}=0.54 kwh/(m³K), then from Equation (12), we can get surface temperature of the structure,

$$\frac{{T}_{η = η} - {T}_{0 , η = η}}{{T}_{η = 0} - {T}_{0 , η = 0}} = \frac{1}{1 + 1.148 \cdot η} \qquad ( 13 )$$

If η=1, Equation (13) then becomes

$$\frac{{T}_{η = 1} - {T}_{0 , η = 1}}{{T}_{η = 0} - {T}_{0 , η = 0}} = 0.466 \qquad ( 14 )$$

If T_{η=0}−T_{0,η=0}>0, the surface is receiving heat energy from sun radiation and temperature increases. Thus, the temperature of the surface of the structure reduced by a possible maximum of 53.4% compared to surface of concrete or asphalt only structure.

If T_{η=0}−T_{0,η=0}<0, the surface is in the process of temperature drop without sun radiation. Thus, compared to surface of concrete or asphalt only structure, Equation (14) shows a possibly maximum increase in temperature by 53.4%.

The effect of water volume ratio η on surface temperature is shown in Table 1.

TABLE 1
Effect of water volume ratio η contained
in structure on surface temperature

| Water volume ratio η | $\vert ( 1 - \frac{{T}_{η = 1} - {T}_{0 , η = 1}}{{T}_{η = 0} - {T}_{0 , η = 0}} ) \vert \times 100 \%$ |
|---|---|
| 0 | 0 |
| 0.1 | 10.3 |
| 0.2 | 18.7 |
| 0.3 | 25.6 |
| 0.4 | 31.5 |
| 0.5 | 36.5 |
| 0.6 | 40.8 |
| 0.7 | 44.6 |
| 0.8 | 47.9 |
| 0.9 | 50.8 |
| 1 | 53.4 |

Similarly, if a TCM is contained in the structure, Equation (8) may be extended to a form of
Q_{CT}=b·A·(T_{C}−T_{C0})·[C_{PC}+η_{TCM}·(C_{PTCM}−C_{PC})]+b·A·η_{TCM}·ΔH (15)

Where η_{TCM} is volume ratio of TCM contained in the structure. C_{PTCM} is average heat capacity of TCM, in kwh/(m³K). ΔH is latent heat of TCM, in kwh/m³. When the temperature increases from a lower temperature towards melting point of TCM, ΔH is negative; when temperature from a higher temperature towards freezing point of TCM, ΔH is positive.

Comparing Equation (15) to Equation (8), and using Equation (10) and assuming T_{b} is constant, as well as C_{PTCM}=C_{PC}, as an approximation, it can be obtained that:

$${T}_{C {η}_{TCM}} - {T}_{C} = \frac{2 \cdot {η}_{TCM} \cdot Δ H}{{C}_{PC}} \qquad ( 16 )$$

For example, if assuming ΔH=50 kwh/m³ and C_{PC}=0.54 kwh/(m³K), then from Equation (16), we can get possibly maximum reduction or increase of surface temperature of the structure due to TCM contained,
T_{Cη}_{_{TCM}}−T_{C}=185.2·η_{TCM} (17)

The surface temperature of the structure and air temperature over the structure can be obtained by solving a group of governing equations described above. In the case of water contained in the structure, a group of equations including Equations (3), (5), (6), (7), (9), (10) and (11), as well as in the case of a TCM contained in the structure, a group of equations including Equations (3), (5), (6), (7), (9), (10) and (15), can be used. Similarly, in the cases of water and one or more TCMs contained in the structure, an extended equation similar to Equation (11) or Equation (15) can be included in the equation group. The solutions to the equation groups can be done by numerical analysis or simulation analysis.

To demonstrate the effectiveness of the present invention, simulation processes by computation have been conducted under the assumptions: sun radiation on the surface of the structure is simulated to be stable and continuous for 5 hours at a constant value, and then 0 for another 5 hours. In addition, the thickness of the concrete or asphalt structure was assumed to be 0.1 m, and thickness or height of air over the structure in question was assumed to be 100 m. Other parameters and conditions in the simulation were: reflectance or albedo of the surface β=0 (which showed net sun radiation on surface), emittance of the surface δ=0.9, coefficient of air absorbing heat energy emitting from the surface of the structure λ=0.5, and coefficient of combined conduction and convection around the surface K_{c}=0.02 kw/(m²K) (which showed a situation of lower air convection condition that may exist on streets with taller buildings).

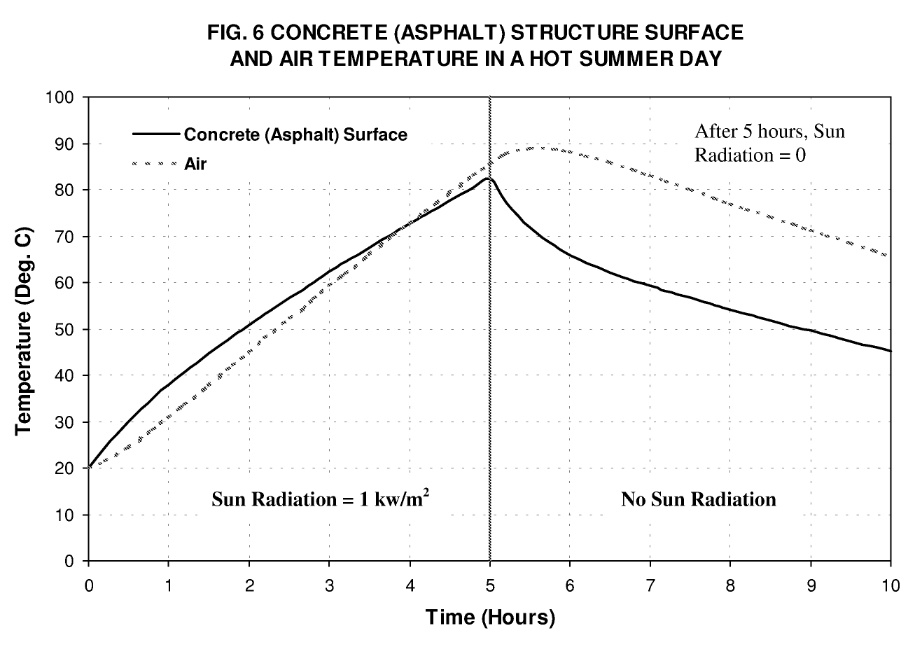

Typical temperature curves of surface of the structure and air over the structure are shown in FIG. 6 in which the total sun radiation after deducted reflectance was 5 kwh/m² that represents the situation in a hot summer day.

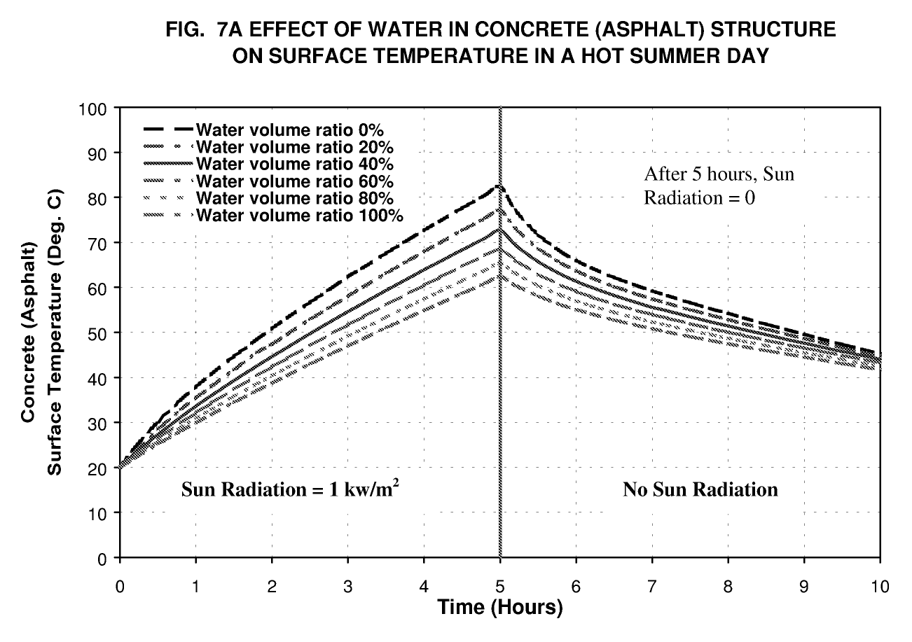

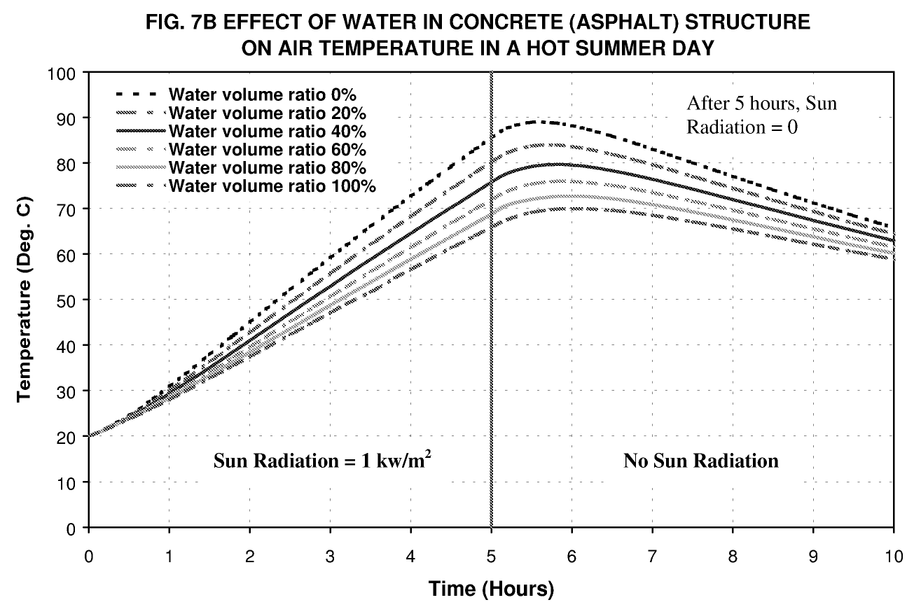

FIG. 7A gives the simulation results of effect of water volume ratio contained in the structure on the surface temperature in a hot summer day with stable and continuous sun radiation of 1 kw/m². All curves in FIG. 7A show that the surface temperature drops with increased water volume ratio in concrete or asphalt structure. The highest temperatures occur at time=5 hours when the sun radiation just stopped after stable and continuous sun radiation of 1 kw/m² for 5 hours. The maximum difference at the highest temperatures is 19.9° C. (difference between 82.3° C. at water volume ratio of 0%, and 62.4° C. at water volume ratio of 100%) which shows the reduction of 24.2%. FIG. 7B shows the temperature of air over the structure in the same conditions as in FIG. 7A. All curves in FIG. 7B show that air temperature drops with increased water volume ratio in concrete or asphalt structure. The highest temperatures occur after the sun radiation stopped for 0.5 to 0.75 hours. The maximum difference at the highest air temperatures is 19.8° C. (difference between 88.9° C. at water volume ratio of 0%, and 69.1° C. at water volume ratio of 100%) which shows the reduction of 22.3%.

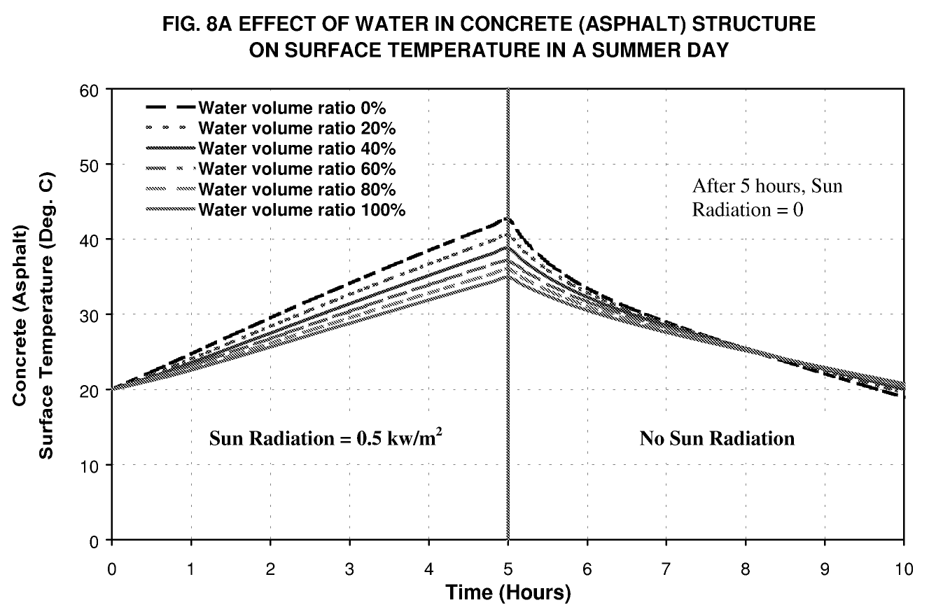

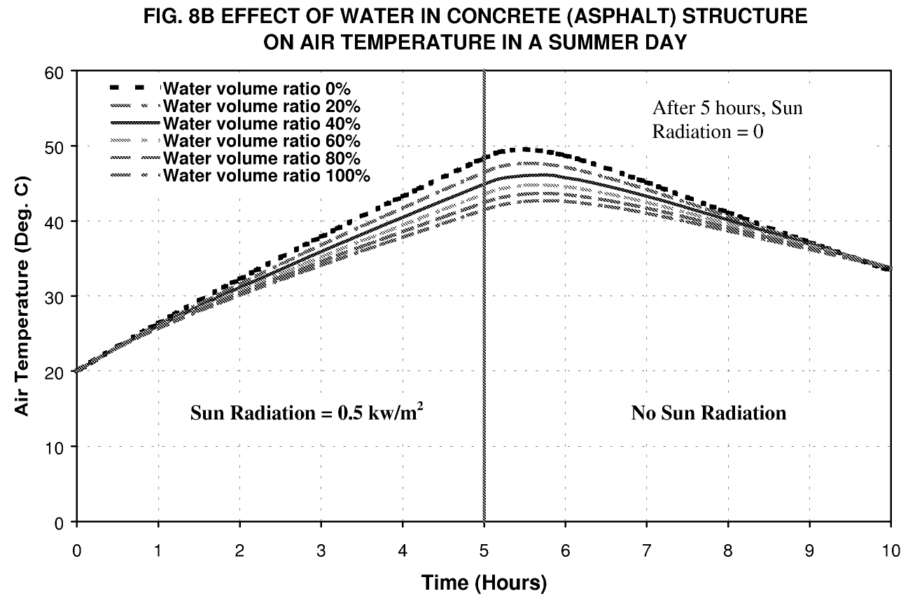

FIG. 8A shows the simulation results of effect of water volume ratio contained in the structure on the surface temperature in a summer day with stable and continuous sun radiation of 0.5 kw/m². All curves in FIG. 8A give that the surface temperature drops with increased water volume ratio in concrete or asphalt structure when temperatures are higher than about 25° C. However, when temperatures are lower than about 25° C., the temperature increases with increased water volume ratio in concrete or asphalt structure. The highest temperatures occur at time=5 hours when the sun radiation just stopped after stable and continuous sun radiation of 0.5 kw/m for 5 hours. The maximum difference at the highest temperatures is 7.7° C. (difference between 42.6° C. at water volume ratio of 0%, and 34.9° C. at water volume ratio of 100%) which shows the reduction of 18.1%. FIG. 8B gives the temperature of air over the structure in the same conditions as in FIG. 8A. All curves in FIG. 8B show that air temperature drops with increased water volume ratio in concrete or asphalt structure. The highest temperatures occur after the sun radiation stopped for about 0.5 hours. The maximum difference at the highest air temperatures is 6.8° C. (difference between 49.5° C. at water volume ratio of 0%, and 42.7° C. at water volume ratio of 100%) which shows the reduction of 13.7%.

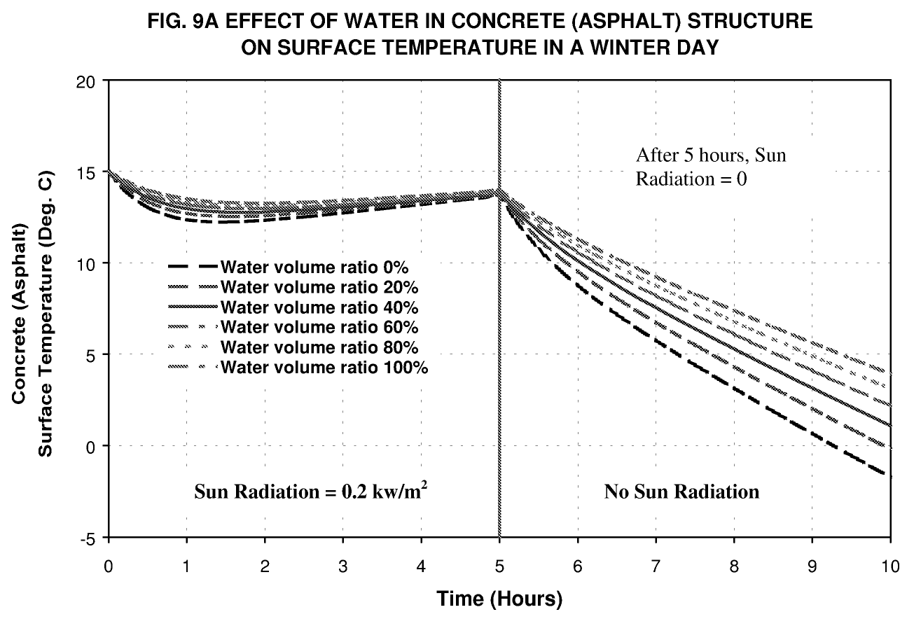

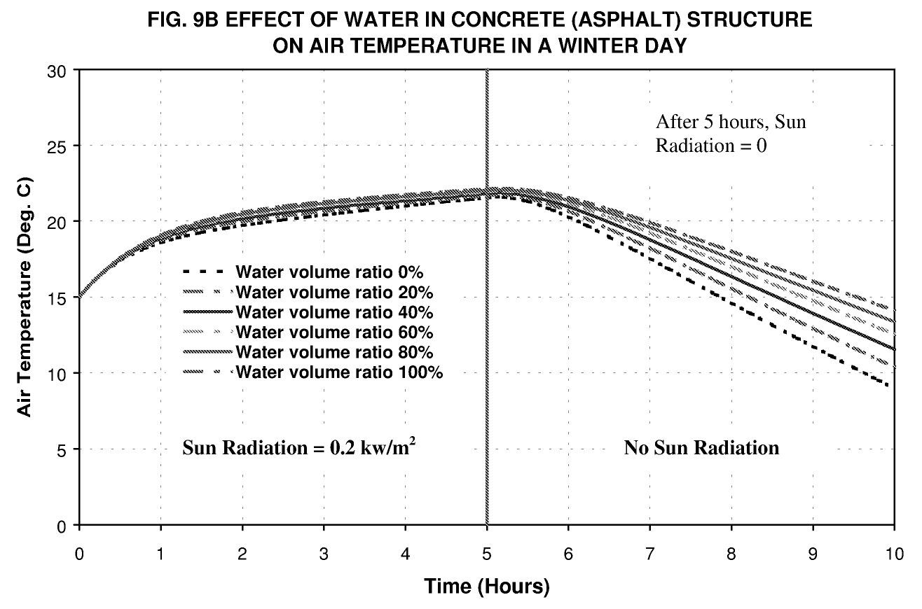

The simulation results shown in FIG. 9A are the effect of water volume ratio contained in the structure on the surface temperature in a winter day with stable and continuous sun radiation of 0.2 kw/m². All curves in FIG. 9A give that the surface temperature increases with increased water volume ratio in concrete or asphalt structure. The maximum difference of increased temperature is 5.6° C. (difference between 3.9° C. at water volume ratio of 100%, and −1.7° C. at water volume ratio of 0%). FIG. 9B gives the temperature of air over the structure in the same conditions as in FIG. 9A. All curves in FIG. 9B show that air temperature increases with increased water volume ratio in concrete or asphalt structure. The maximum difference of increased air temperatures is 5.1° C. (difference between 14.1° C. at water volume ratio of 100%, and 9° C. at water volume ratio of 0%).

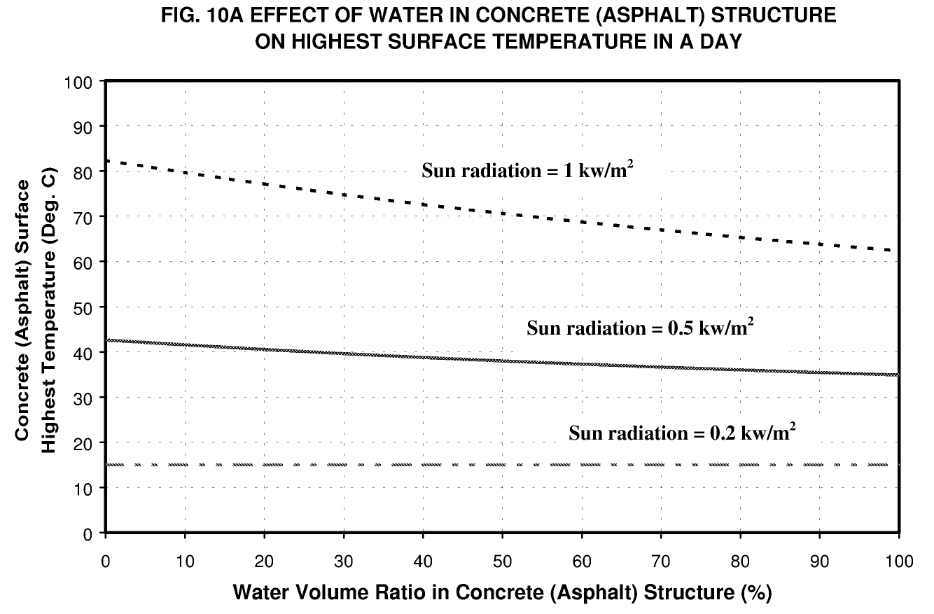

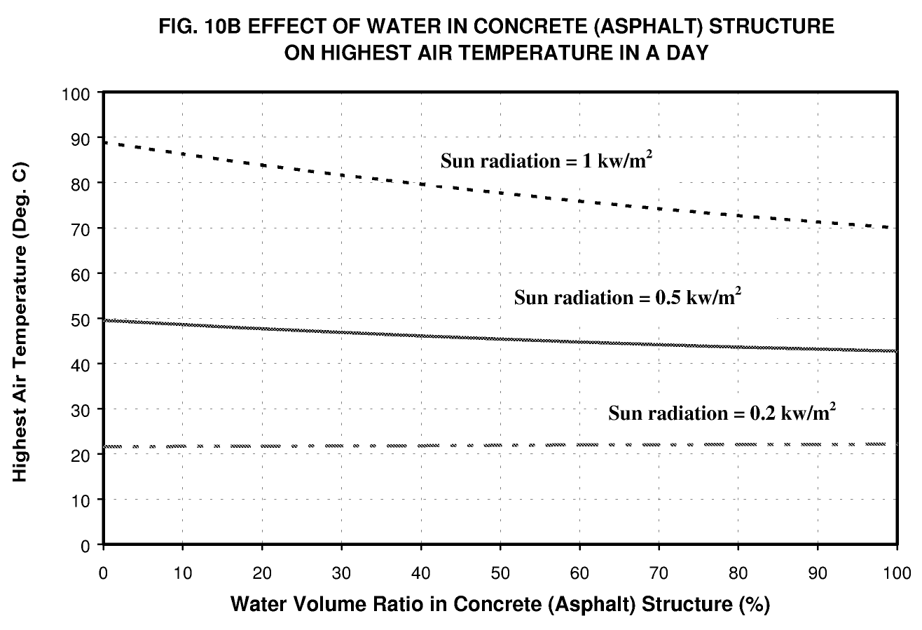

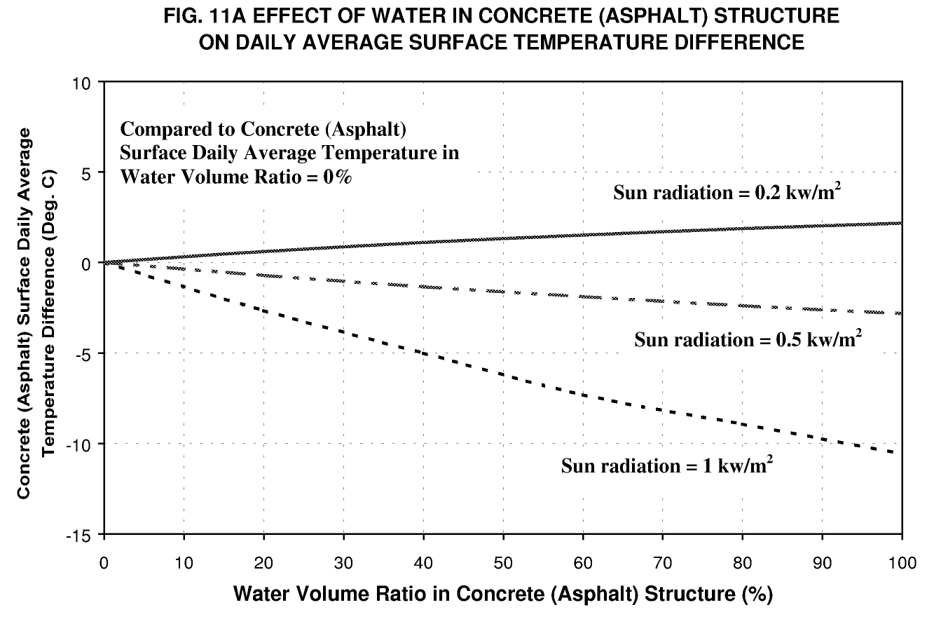

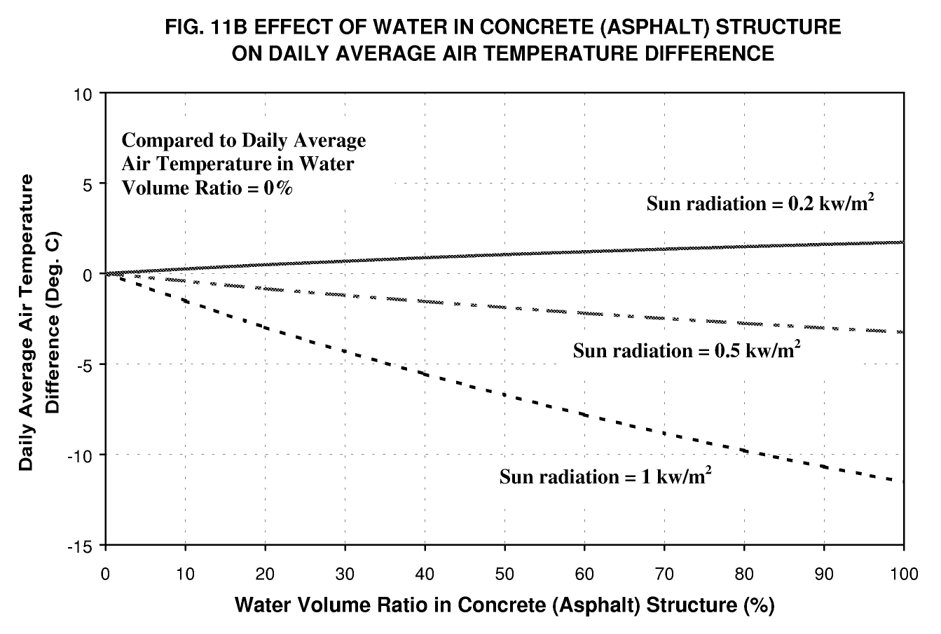

The simulation results above indicate that the water contained in the structure has significant effect on the surface temperature and temperature of air over the structure. FIG. 10A and FIG. 10B summarize the effect of water contained in the structure on highest surface temperature and on the highest air temperature respectively. The difference of daily average temperature between concrete or asphalt only structure and the structure containing water is more important to reveal the effectiveness in the present invention, the results are shown in FIG. 11A and FIG. 11B. It can be summarized that, the daily average temperature of surface can be reduced by a maximum of 10.6° C. in a hot summer day, and the daily average air temperature can be reduced by a maximum of 11.5° C. In winter time in the case of sun radiation of W=0.2 kw/m², the daily average temperature of surface can be increased by a maximum of 2.2° C., and the daily average air temperature can be increased by a maximum of 1.7° C.

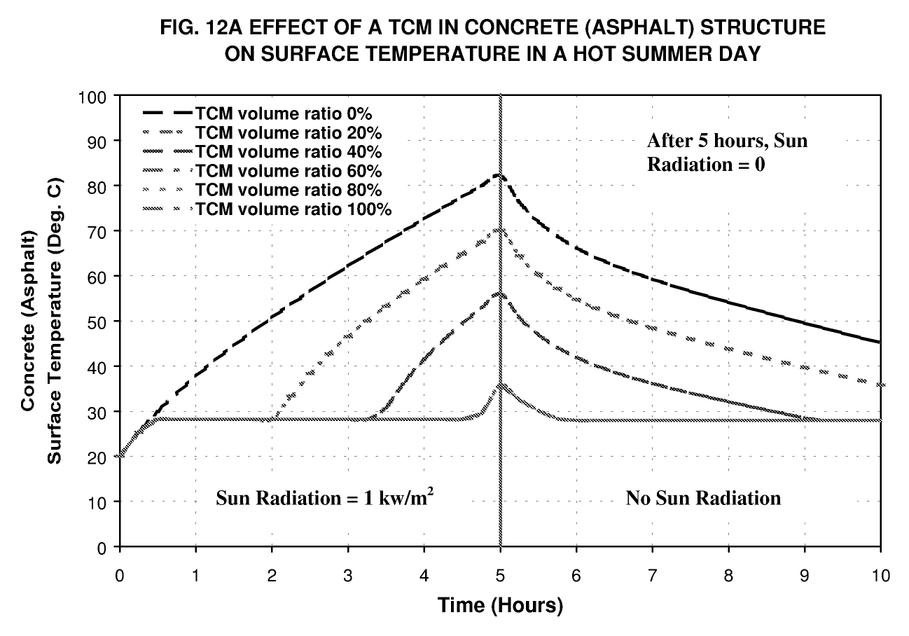

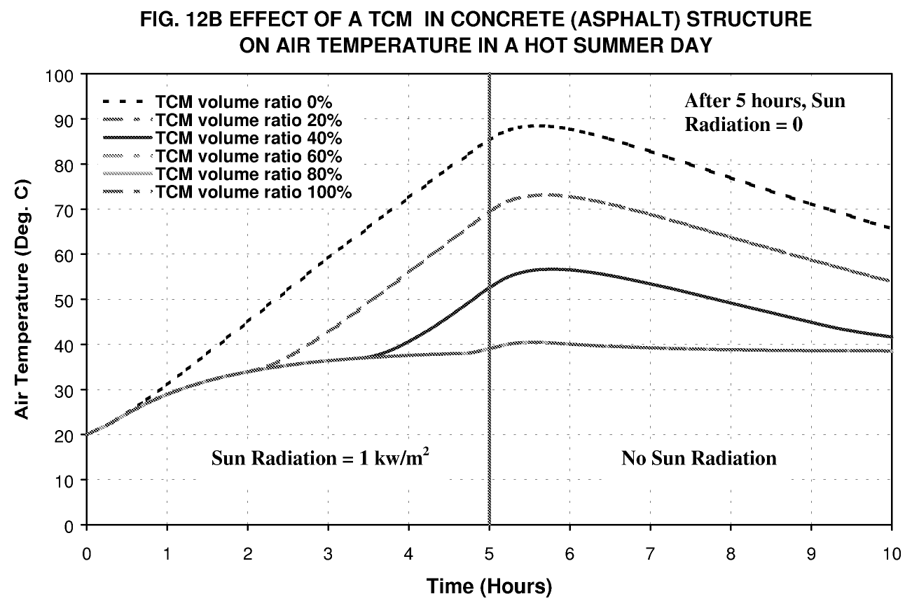

Very similar to the simulation analysis of water contained in the structure, the structure containing TCM in the present invention has more significant effect on regulating or controlling surface and air temperature. In the simulation the TCM used is 1-dodecanol, having melting point of 24° C. and latent heat of 50 kwh/m³. FIG. 12A gives the simulation results of effect of TCM volume ratio contained in the structure on the surface temperature in a hot summer day with stable and continuous sun radiation of 1 kw/m². All curves in FIG. 12A show that the surface temperature drops with increased TCM volume ratio in concrete or asphalt structure. The highest temperatures occur at time=5 hours when the sun radiation just stopped after stable and continuous sun radiation of 1 kw/m for 5 hours. When TCM volume ratio is 60% or more, the temperature curves overlay together with the same effect. The maximum difference at the highest temperatures is 46.5° C. (difference between 82.3° C. at TCM volume ratio of 0%, and 35.8° C. at TCM volume ratio of 60% or more) which shows the reduction of 56.5%. FIG. 12B shows the temperature of air over the structure in the same conditions as in FIG. 12A. All curves in FIG. 12B show that air temperature drops with increased TCM volume ratio in concrete or asphalt structure. When TCM volume ratio is 60% or more, the air temperature curves overlay together with the same effect. The highest temperatures occur after the sun radiation stopped for 0.5 to 0.75 hours. The maximum difference at the highest air temperatures is 48.4° C. (difference between 88.9° C. at TCM volume ratio of 0%, and 40.5° C. at TCM volume ratio of 60% or more) which shows the reduction of 54.4%.

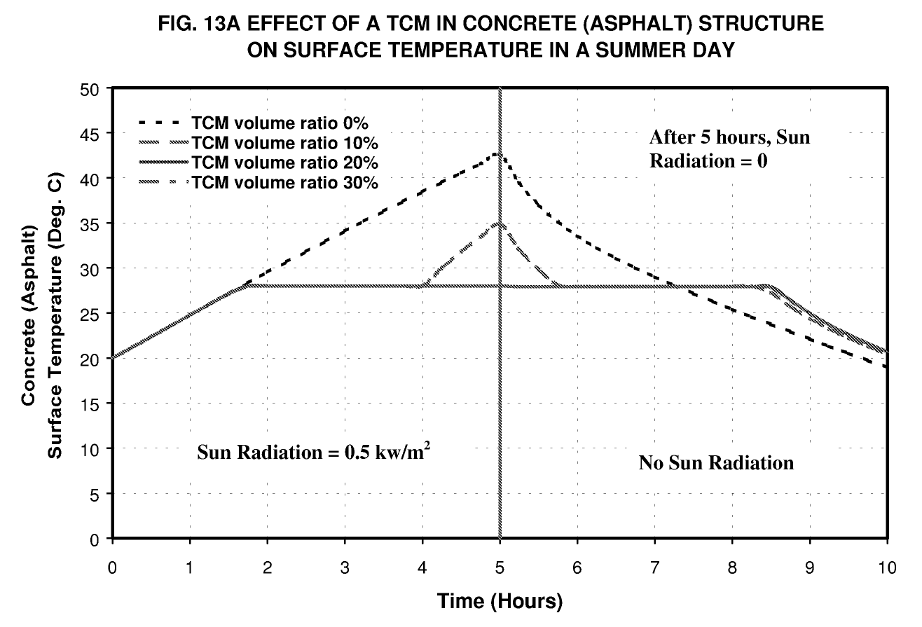

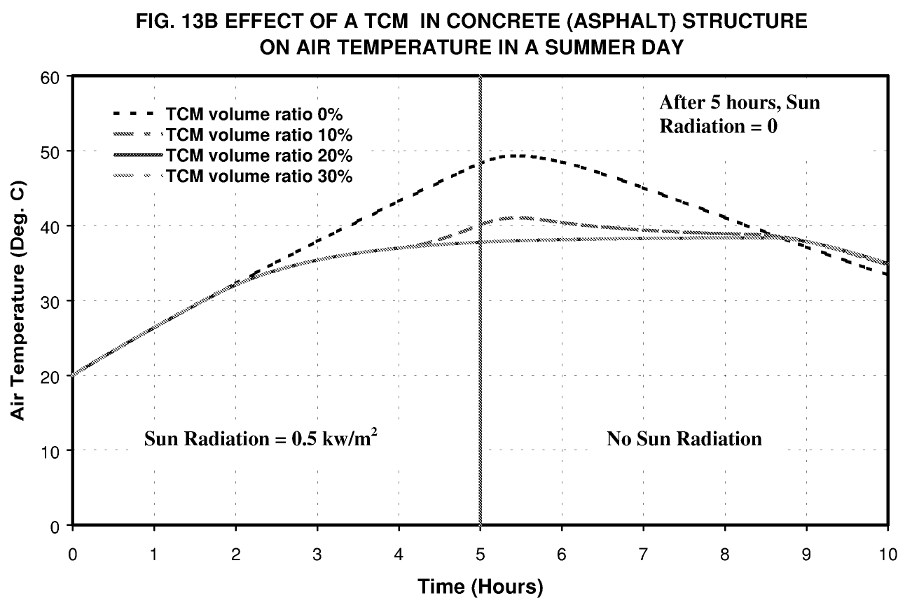

FIG. 13A shows the simulation results of effect of TCM volume ratio contained in the structure on the surface temperature in a summer day with stable and continuous sun radiation of 0.5 kw/m². All curves in FIG. 13A give that the surface temperature drops with increased TCM volume ratio in concrete or asphalt structure when temperatures are higher than about between 26° C. and 28° C. However, when temperatures are lower than about between 26° C. and 28° C., the temperature increases with increased TCM volume ratio in concrete or asphalt structure. When TCM volume ratio is 20% or more, the surface temperature curves overlay together with the same effect. The highest temperatures occur at time=5 hours when the sun radiation just stopped after stable and continuous sun radiation of 0.5 kw/m² for 5 hours. The maximum difference at the highest temperatures is 14.6° C. (difference between 42.6° C. at TCM volume ratio of 0%, and 28° C. at TCM volume ratio of 20% or more) which shows the reduction of 34.3%. FIG. 13B gives the temperature of air over the structure in the same conditions as in FIG. 13A. All curves in FIG. 13B show that air temperature drops with increased TCM volume ratio in concrete or asphalt structure. The highest temperatures occur after the sun radiation stopped for about 0.5 hours. The maximum difference at the highest air temperatures is 11.5° C. (difference between 49.5° C. at TCM volume ratio of 0%, and 38° C. at TCM volume ratio of 20% or more) which shows the reduction of 23.2%.

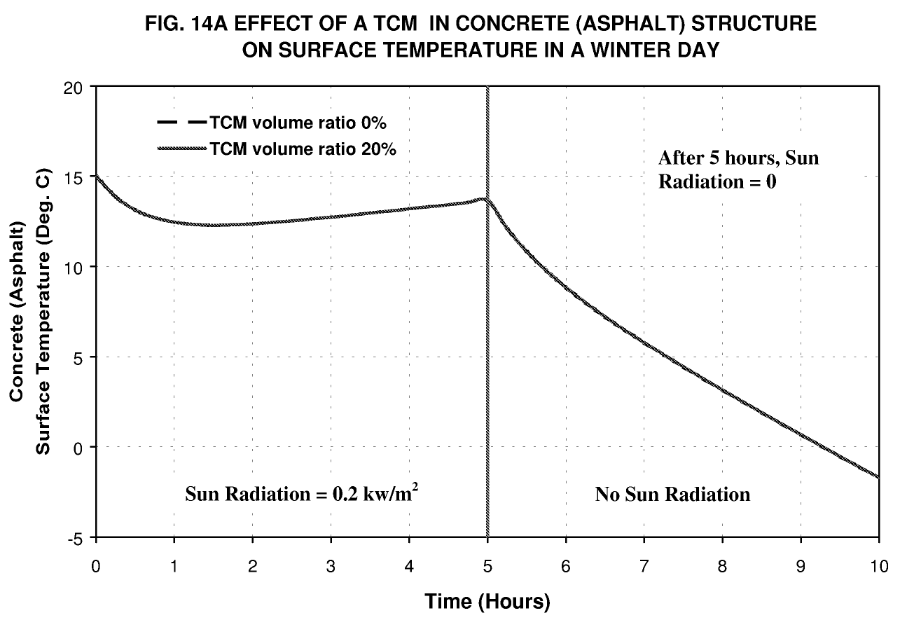

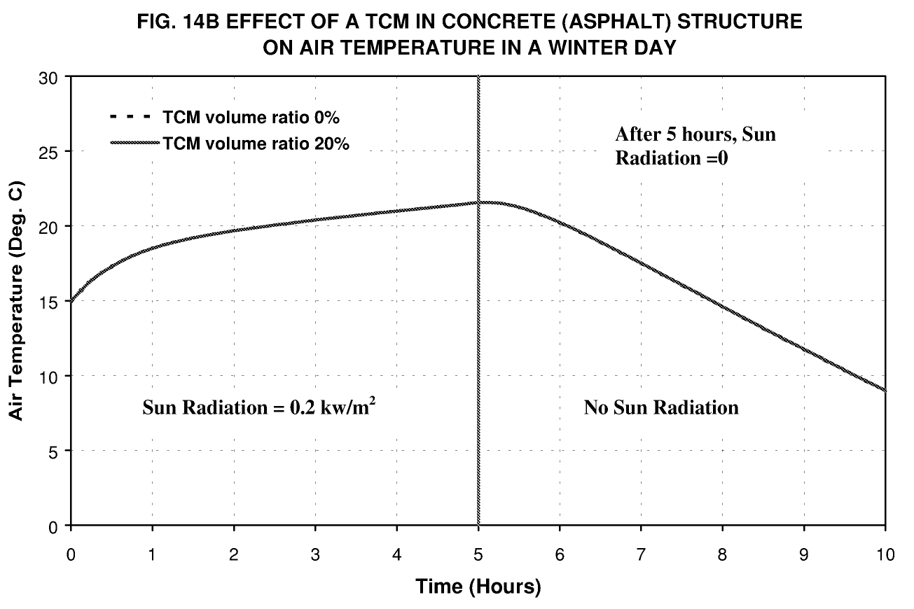

All curves in FIG. 14A and FIG. 14B overlay together and indicate no effect of TCM volume ratio contained in the structure on the surface and air temperature in a winter day with stable and continuous sun radiation of 0.2 kw/m² because the temperature is lower than the melting point of TCM.

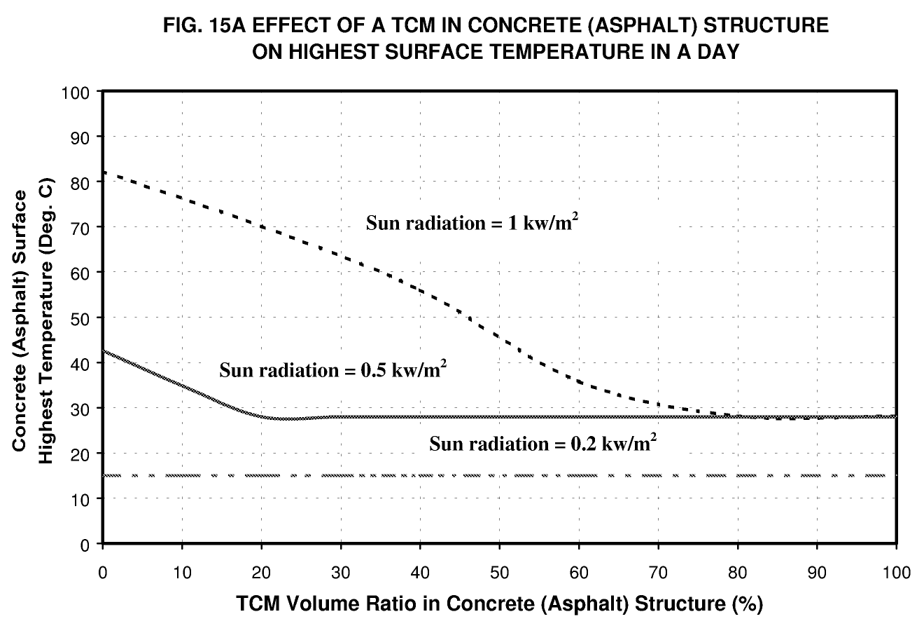

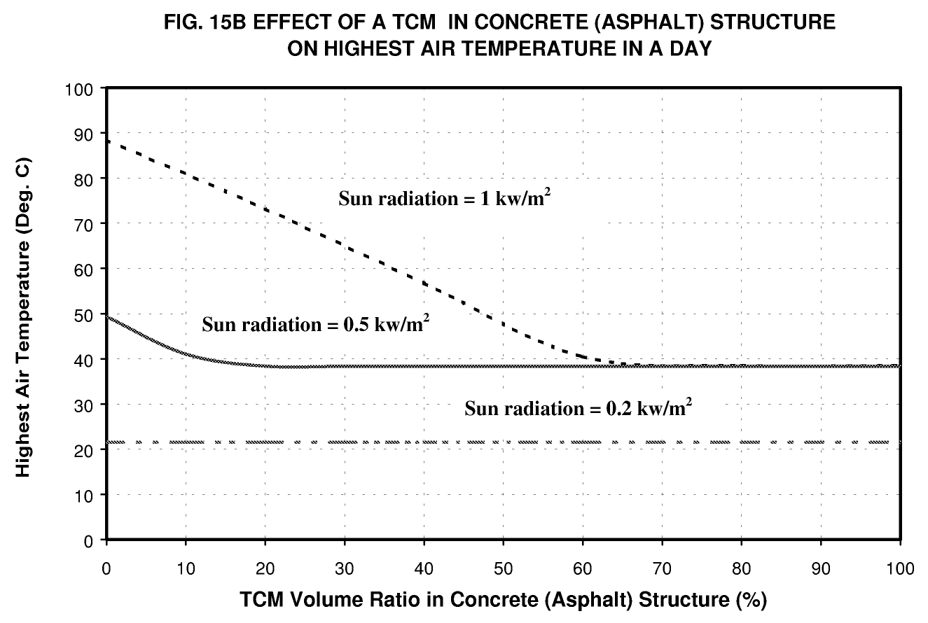

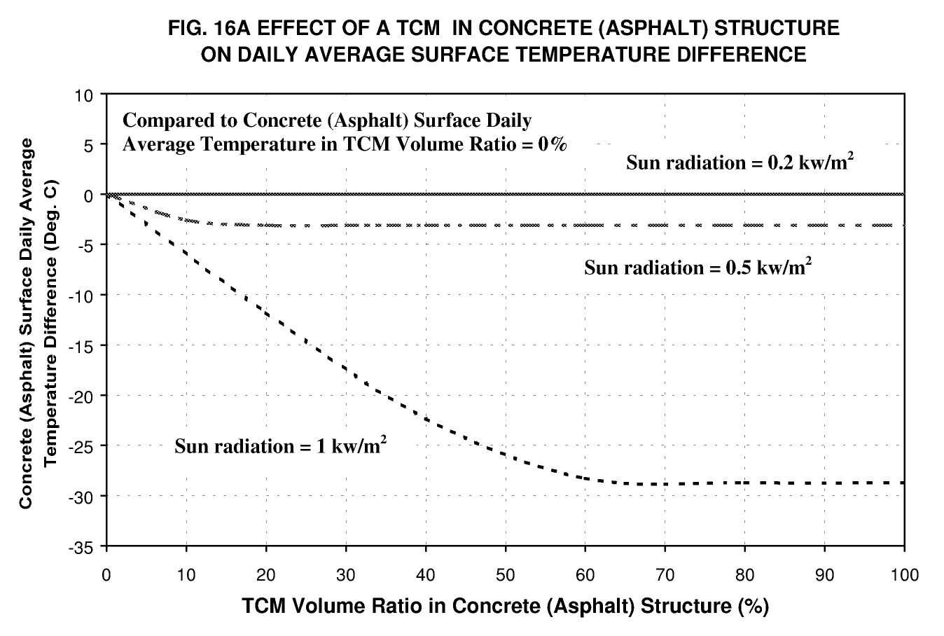

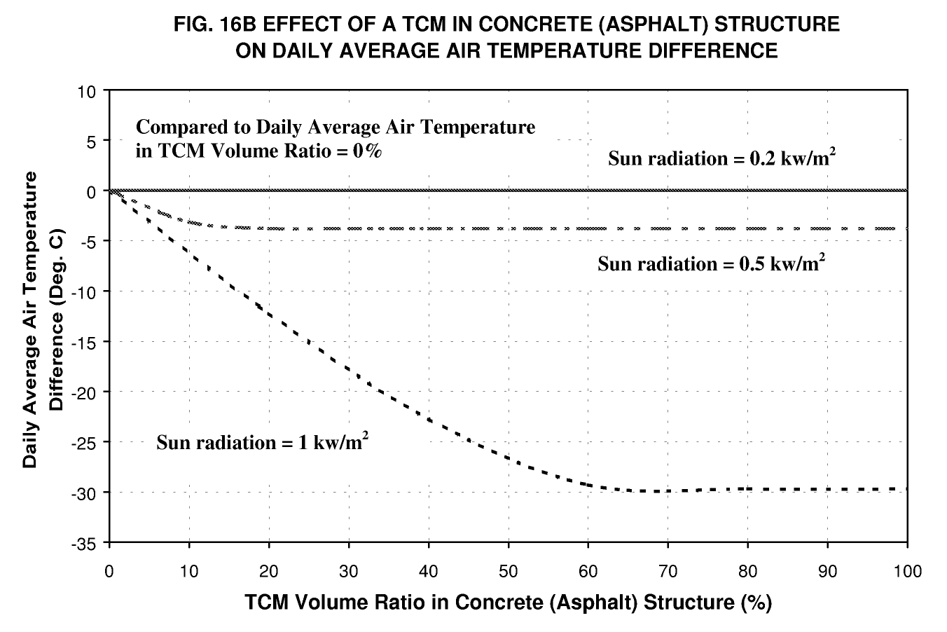

The simulation results above indicate that TCM contained in the structure has significant effect on the surface temperature and temperature of air over the structure in summer time, but has no effect in winter time if temperature is lower than melting point of TCM. FIG. 15A and FIG. 15B summarize the effect of TCM contained in the structure on highest surface temperature and on the highest air temperature respectively. The difference of daily average temperature between concrete or asphalt only structure and the structure containing TCM is more important to reveal the effectiveness in the present invention, the results are shown in FIG. 16A and FIG. 16B. It can be summarized that, the daily average temperature of surface can be reduced by a maximum of 28.7° C. in a hot summer day, and the daily average air temperature can be reduced by a maximum of 29.7° C.

The daily highest temperature and daily average temperature in the simulation analysis are summarized in Table 2. And Table 3 summarizes the maximum effect of water and TCM contained in the structure.

TABLE 2
Daily highest and daily average temperature in the simulation analysis

| | Daily temperature (° C.) | | | | Daily average | |
|---|---|---|---|---|---|---|
| | Highest | | Lowest | | temperature (° C.) | |
| Conditions | Surface | Air | Surface | Air | Surface | Air |
| A hot summer day | 82.3 | 88.9 | — | — | 56.6 | 65.6 |
| A summer day | 42.6 | 49.5 | — | — | 29.8 | 38.7 |
| A winter day | | | −1.7 | 9.0 | 8.9 | 17.8 |

TABLE 3
Temperature control capacity of water and TCM contained in the structure

| | Maximum control | | | | Maximum control capacity | | | |
|---|---|---|---|---|---|---|---|---|
| | capacity of highest | | | | of daily average | | | |
| | temperature (° C.) | | | | temperature (° C.) | | | |
| | Water | | TCM | | Water | | TCM | |
| Conditions | surface | air | Surface | air | surface | air | surface | air |
| A hot Summer day | −19.9 | −19.8 | −46.5 | −48.4 | −10.6 | −11.5 | −28.7 | −29.7 |
| A summer Day | −7.7 | −6.8 | −14.6 | −11.5 | −2.8 | −3.3 | −3.1 | −3.8 |
| A winter day | +5.6 | +5.1 | 0 | 0 | +2.2 | +1.7 | 0 | 0 |

These simulation results also indicate that the present invention can control temperature in the way of lowering temperature when it is higher and increasing temperature when it is lower.

In the simulation of TCM contained in the structure, in wintertime or colder days, if the temperature is lower than melting point of the TCM used, there is no effect on regulating or controlling temperature. This result suggests that water or/and TCMs with lower melting points be combined with together to have mutual effect of reduced temperature in summertime or hotter periods and increased temperature in wintertime or colder days.

It is estimated from the simulation analysis that cooling energy consumption may be reduced by 25%˜50% in summertime or hotter periods provided that 20%˜30% of the structures in cities are constructed or constituted with the present invention, and “tool island” may not be a dream if more structures are constructed or constituted with the present invention. In the same way, “warm island” in wintertime or colder periods may also be possible, which may be expected to reduce the heating energy demand by 10%˜25%.

The embodiments of the invention in which an exclusive property or privilege is claimed are defined as follows:

1. A method of regulating and controlling surface and air temperature of concrete or asphalt structure and the like (the said structure) which constructs or constitutes pavements, roofs, parking lots, walls of buildings and the like, by encapsulating, incorporating and/or containing water or/and one or more temperature (thermal) control materials (TCMs) in the said structure, thus lowering temperature of the structure and air temperature around the structure in summertime or hotter periods and reducing “heat island” effect.

2. The method according to claim 1 wherein water and one or more TCMs encapsulated, incorporated and/or contained in the said concrete or asphalt structure are from 0.01% to 99.99% of volume ratio.

3. Further in claim 1 in which water or/and one or more TCMs encapsulated, incorporated and/or contained in the said structure are contained in microspheres, microcapsules, capsules, particles, small hollow balls, closed-end tubes or pipes, containers and the like or dispersed and distributed in the said structure.

4. Further according to claim 3 in which the shell materials for microspheres, microcapsules, capsules, particles, small hollow balls, closed-end tubes or pipes and containers can be metals, alloys, polymers, rubbers, plastics, natural or synthetic materials.

5. Further in claim 3 in which the microspheres, microcapsules, capsules, particles, small hollow balls, closed-end tubes or pipes and containers containing water and/or TCMs are in various dimensions, shapes and sizes.

6. Further in claim 1, claim 3, claim 4 and claim 5 in which the microspheres, microcapsules, capsules or particles can be formed according to conventional methods well known to those skilled in the prior art.

7. Further according to claim 1, claim 3, claim 4, claim 5 and claim 6 in which the particles 2 in FIG. 1 can be particles including expanded perlite particles or/and exfoliated or expanded vermiculite particles and the like that have high capacities of absorbing water or TCMs, or/and can also be particles of TCMs.

8. Further according to claim 7 wherein after absorption of water and/or TCMs the expanded perlite particles or/and exfoliated or expanded vermiculite particles are coated or the entries of pores at the particle surfaces are sealed with one or more polymers or/and binders such as epoxy resin, rubbers, plastics, or others and mixed with concrete or asphalt.

9. The method according to claim 1 in which the water used may be natural water, or water from various water sources.

10. Further according to claim 1 and claim 9 wherein the water may contain impurity, with or without additives which are natural or synthetic, which may be used for the purpose of regulating the freezing point and boiling point of water.

11. Further according to claim 1 in which the TCMs may be phase change materials (PCMs), including solid-liquid PCMs, solid-solid PCMs and other PCMs, or/and materials or matters used to control or regulate temperature by chemical bonds or chemical reactions and have capacities to store thermal energy.

12. Further according to claim 1 wherein typical TCMs used can be 1-dodecanol, having melting point of about 24° C. and latent heat of about 50 kwh/m³, as well as paraffin waxes and salt hydrates with melting points of 10˜60° C.

13. The method in claim 1 which can be used to raise the surface temperature of the said concrete or asphalt structure and air temperature over the said structure in wintertime or colder periods to save heating energy.
